(19) United States
(12) Patent Application Publication
(10) Pub. No.: US 2018/0326581 A1
(43) Pub. Date: Nov. 15, 2018

(54) SYSTEM AND METHOD FOR AUCTION-BASED AND ADAPTIVE MULTI-THRESHOLD MULTI-AGENT TASK ALLOCATION

(71) Applicant: KING FAHD UNIVERSITY OF PETROLEUM AND MINERALS, Dhahran (SA)

(72) Inventors: Uthman BAROUDI, Dhahran (SA); Mohammed Al-Shaboti, Dhahran (SA)

(73) Assignee: KING FAHD UNIVERSITY OF PETROLEUM AND MINERALS, Dhahran (SA)

(21) Appl. No.: 15/820,973

(22) Filed: Nov. 22, 2017

Related U.S. Application Data
(60) Provisional application No. 62/504,842, filed on May 11, 2017.

(51) Int. Cl. B25J 9/16; G06N 5/04

(52) U.S. Cl. CPC B25J 9/1628; G06N 5/048

(57) ABSTRACT

A multi-robot task allocation system includes a plurality of robots communicably coupled via a network. Additionally, the multi-robot task allocation system includes a remote device communicably coupled to the plurality of robots via the network, wherein each of the plurality of robots includes processing circuitry configured to determine when an auction to perform a task is open for bidding. Further, the processing circuitry can calculate a bid for the task, transmit the bid to an auctioneer, receive allocation of the task in response to transmitting the maximum bid, and travel to and execute the allocated task in response to receiving allocation of the task, while also participating in any subsequent auctions.

### CROSS-REFERENCE TO RELATED APPLICATION

This application claims the benefit of U.S. Provisional Application No. 62/504,842, filed May 11, 2017, which is herein incorporated by reference in its entirety.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Robotic networks have proliferated in industrial and scientific applications, thereby attracting research attention because of their computational, sensing, communication, and movement capabilities. They are suitable for use in a wide range of applications where human intervention is limited or not allowed, such as search and rescue operations, surveillance, logistics, and humanitarian demining, as well as in applications for which there are economic benefits for using mobile robots, such as farming or production line applications. The multi-robot task allocation (MRTA) problem has been studied for different system configurations and scenarios, and there are various proposed centralized and distributive methods. The dominated distributed MRTA methods are market-based (aka auction-based) and threshold-based algorithms. In the market-based approach, robots negotiate for a task using auction mechanism in which the auctioneer assigns the task to the highest bidders. In contrast to the auction-based, threshold-based allows each robot to determine by itself without explicit coordination. A robot accepts a task if its “tolerance” surpasses some threshold, otherwise, a task will be ignored.

A prior study compares market-based and threshold-based approaches indicates that market-based approach is more efficient (with the cost of communication) when information is accurate. In contrast, when the information is not accurate, threshold-based provides same quality task, accurate, threshold-based produces the same performance as market-based at a fraction of the cost. Analytical study, by Coldingay et. al, for the effect of load on the performance of market-based and threshold-based approaches shows that threshold-based outperforms market-based under high load level while market-based outperforms threshold-based under low load. Murugaan et. al introduced a task allocation mechanism based on k-means clustering which considers minimizing the traveled distance as well as balancing the load among the available robots, through three stages a) clustering the tasks into n clusters using k-means clustering technique, b) calculate the travel cost between robots and clusters 3) assign the clusters to the robots. With assumption that all tasks information are known to be classified before assigned to the robots. Another study considers multi-objectives in which auction-based approach is used to solve multi-objectives which are: remaining energy after task executed, the total time for completion the task, priority of the task. A team of robots is divided into clusters each of which consists of a coordinator and robots. A coordinator is responsible for arranging the auction and distributing task information. Multi-robot FIS for dynamic hunting scenario was proposed by Duan et. al, where they used FIS to guide the team of robots to encircle the target. Results show the usefulness of FIS in estimating the target location based on its motion and the distance between the target and each robot in the team. Krieger et. al proposed an activation-threshold task-allocation approach to divide the labor among the robot's team and used a forging scenario in which the task is to maintain certain level of energy in the nest. The experiments demonstrate that activation-threshold divides the load efficiently. See M. B. Dias, R. Zlot, N. Kalra, and A. Stentz, “Market-based multi-robot coordination: A survey and analysis,” Proc. of IEEE, vol. 94, pp. 1257-1270, 2006; Krieger, Michael J B, and Jean-Bernard. Billeter. “The call of duty: Self-organised task allocation in a population of up to twelve mobile robots.” Robotics and Autonomous Systems 30.1 (2000): 65-84; Agassounon, William, and Alcherio Martinoli. “Efficiency and robustness of threshold-based distributed allocation algorithms in multi-agent systems,” in Proc. of the first international joint conference on Autonomous agents and multiagent systems: part 3. ACM, 2002; S. Koenig, C. Tovey, M. Lagoudakis, D. Kempe, P. Keskinocak, A. Kleywegt, A. Meyerson, and S. Jain, “The Power of Sequential Single-Item Auctions for Agent Coordination,” in Proc of AAAI, 2006; Lagoudakis, Michail G., et al. “Auction-Based Multi-Robot Routing.” Robotics: Science and Systems. Vol. 5. 2005; Lawler, Eugene L., “The traveling salesman problem: a guided tour of combinatorial optimization,” Wiley-Interscience Series in Discrete Mathematics (1985); Lee, D-H., Sheir Afgen Zaheer, and J-H. Kim. “A Resource-Oriented, Decentralized. Auction Algorithm for Multirobot Task Allocation,” IEEE Transactions on Automation Science and Engineering, 2014; Mi, Zhenqiang, et al. “Connectivity preserving task allocation in mobile robotic sensor network,” in proc. of International Conference on Communications (ICC), 2014; W. Sheng, Q. Yang, J. Tan, N. Xi. “Distributed multi-robot coordination in area exploration.” Robotics and Autonomous Systems, 54 (2006), pp. 945-955; Elango, Murugappan, Subramanian Nachiappan, and Manoj Kumar Tiwari, “Balancing task allocation in multi-robot systems using K-means clustering and auction based mechanisms,” Expert Systems With Applications, vol. 38, no. 6, pp. 6486-6491, 2011; Gong, Jianwei, et al. “A GA based combinatorial auction algorithm for multi-robot cooperative hunting.” Computational Intelligence and Security, 2007 International Conference on. IEEE, 2007; B. P. Gerkey and M. J. Matari, “Sold!: Auction methods for multirobot coordination,” Robotics and Automation, IEEE Transactions on, vol. 18, no. 5, pp. 758-768, 2002; A. T. Tolmidis and L. Petrou, “Multi-objective optimization for dynamic task allocation in a multi-robot system,” Engineering Applications of Artificial Intelligence, vol. 26, no. 5, pp. 1458-1468, 2013; Zheng, Xiaoming, Sven Koenig, and Craig Tovey, “Improving sequential single-item auctions,” in proc. of International Conference on Intelligent Robots and Systems (IEEE/RSJ), 2006; B. P. Gerkey and M. J. Mataric, BA., “Formal analysis and taxonomy of task allocation in multi-robot systems,” Int. J. Robot. Res., vol. 23, no. 9, pp. 939-954, 2004; Sallam, Gamal, and Uthman Baroudi. “COVER: A Cooperative Virtual Force Robot Deployment Technique.” Computer and Information Technology; Ubiquitous Computing and Communications; Dependable, Autonomic and Secure Computing; Pervasive Intelligence and Computing (CIT/IUCC/DASC/PICOM), 2015 IEEE International Conference on. IEEE, 2015; Ahmed, Adel Ali, Mohammed Al-Shaboti, and Abdulhakim Al-Zubairi. “An Indoor Emergency Guidance Algorithm Based on Wireless Sensor Networks,” Cloud Computing (ICCC), 2015 International Conference on. IEEE, 2015; Nasser, Nidal, et al. “An efficient Wireless Sensor Network-based water quality monitoring system.” Computer Systems and Applications (AICCSA), 2013 ACS International Conference on. IEEE, 2013; Seelan, Santhosh K., et al. “Remote sensing applications for precision agriculture: A learning community approach.” Remote Sensing of Environment 88.1 (2003): 157-169; Triantaphyllou, Evangelos. Multi-criteria decision making methods: a comparative study. Vol. 44. Springer Science R. Business Media, 2013; Johnson, D. S. and McGeoch, L. A., “The traveling salesman problem: A case study in local optimization,” Local search in combinatorial optimization, pp. 215-310, 1997; Webots, “http://www.cyberbotics.com”, Commercial Mobile Robot Simulation Software, Cyberbotics Ltd; Kheperalll, “http://www.k-team.com/mobile-robotics-products/old-products/khepera-iii”, K-team Mobile Robotics, K-Team Corporation; A. O'Dwyer, Handbook of PI and PID controller tuning rules. World Scientific, 2009, vol. 57; R. E. Bellman and L. A. Zadeh, “Decision-making in a fuzzy environment,” Management science, vol. 17, no. 4, pp. B-141, 1970; Z. Mi, Y. Yang, H. Ma, and D. Wang, “Connectivity preserving task allocation in mobile robotic sensor network,” in Communications (ICC), 2014, IEEE International Conference on. IEEE, 2014, pp. 136-141; N. Kalra and A. Martinoli, “Comparative study of market-based and threshold-based task allocation,” in Distributed autonomous robotic systems 7. Springer, 2006, pp. 91-101; Goldingay, Harry, and Jort Van Mourik. “The effect of load on agent-based algorithms for distributed task allocation.” Information sciences 222 (2013): 66-80; Elango, Murugappan, Subramanian Nachiappan, and Manoj Kumar Tiwari. “Balancing task allocation in multi-robot systems using K-means clustering and auction based mechanisms.” Expert Systems with Applications 38.6 (2011): 6486-6491; Duan, Yong, Xiao Huang, and Xia Yu. “Multi-robot dynamic virtual potential point hunting strategy based on FIS.” Guidance, Navigation and Control Conference (CGNCC), 2016 IEEE Chinese. IEEE, 2016; Krieger, Michael J B, and Jean-Bernard Billeter. “The call of duty: Self-organised task allocation in a population of up to twelve mobile robots.” Robotics and Autonomous Systems 30.1 (2000): 65-84; Tolmidis, Avraam Th, and Loukas Petrou. “Multi-objective optimization for dynamic task allocation in a multi-robot system.” Engineering Applications of Artificial Intelligence 26.5 (2013): 1458-1468, each incorporated herein by reference in their entirety.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The problem of assigning a set of tasks to a set of robots to optimize certain metrics is called multi-robot task allocation (MRTA), and it is considered to be one of the main challenges in multi-robot systems (MRS). Furthermore, it is more challenging if tasks must be assigned in a distributed manner in real-time as they appear.

Therefore, it is one objective of the present disclosure to provide a system for multirobot task allocation which can be implemented with three objectives and a complex fuzzy logic inference system to combine the three objectives.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

According to embodiments of the disclosed subject matter, a multi-robot task allocation system includes a plurality of robots communicably coupled via a network. Additionally, the multi-robot task allocation system includes a remote device communicably coupled to the plurality of robots via the network, wherein each of the plurality of robots includes processing circuitry configured to determine when an auction to perform a task is open for bidding. Further, the processing circuitry can calculate a bid for the task, transmit the bid to an auctioneer, receive allocation of the task in response to transmitting the maximum bid, and travel to and execute the allocated task in response to receiving allocation of the task, while also participating in any subsequent auctions.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary multi-robot system according to one or more aspects of the disclosed subject matter;

FIG. 2 illustrates exemplary input variables for a fitness HS system according to one or more aspects of the disclosed subject matter;

FIG. 3 illustrates a distance input variable and load input variable according to one or more aspects of the disclosed subject matter;

FIG. 4 illustrates the quality input membership function according to one or more aspects of the disclosed subject matter;

FIG. 5A illustrates the output variable membership function according to one or more aspects of the disclosed subject matter;

FIG. 5B illustrates a table of membership functions according to one or more aspects of the disclosed subject matter;

FIG. 6 illustrates an exemplary distance threshold diagram 600 according to one or more aspects of the disclosed subject matter;

FIG. 7 illustrates a graph of a maximum δ that corresponds to a minimum number of iterations required to satisfy the distance threshold value according to one or more aspects of the disclosed subject matter;

FIG. 8 illustrates an exemplary network schematic diagram according to one or more aspects of the disclosed subject matter;

FIG. 9 illustrates a total traveled distance plot of the FIS auction-based approach according to one or more aspects of the disclosed subject matter;

FIG. 10 illustrates a total traveled distance plot of the adaptive multi-threshold approach according to one or more aspects of the disclosed subject matter;

FIG. 11 illustrates a plot corresponding to average quality of executed tasks per robot with different numbers of tasks in the FIS auction-based approach according to one or more aspects of the disclosed subject matter;

FIG. 12 illustrates a plot corresponding to average quality of executed tasks per robot with different numbers of tasks in the adaptive multi-threshold approach according to one or more aspects of the disclosed subject matter;

FIG. 13 illustrates a plot corresponding to average number of task executions per robot in the FIS auction-based approach according to one or more aspects of the disclosed subject matter;

FIG. 14 illustrates a plot 1400 of average number of task executions per robot in the adaptive multi-threshold approach according to one or more aspects of the disclosed subject matter; and

FIG. 15 is a hardware block diagram of a server according to one or more exemplary aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

A system for assigning tasks in a distributed manner in real-time as they appear, as further described herein, can include auction-based and threshold-based approaches. Auction-based and threshold-based are the prevalent approaches for multi-robot distributed task allocation. These two approaches can be evaluated under a multi-objective dynamic task allocation scenario. A fuzzy inference system (FIS) can be used in the auction-based approach to convert the objectives into a representative bid value. For example, the FIS auction-based approach can outperform the adaptive threshold-based approach in terms of load balancing, whereas adaptive threshold-based can produce better results in tennis of traveled distance. Additionally, both approaches have no significant difference in quality satisfaction objective.

The advantages of robotic networks can include the flexibility of modification of robotic networks to match different application scenarios. Another advantage includes the robustness of multi-robot systems (MRSs) against failure and parallel operation, which leads to time-efficient systems, for example.

A team of robots can map a specific area and identify unsafe zones, for example. The team can locate tasks either by itself if the robots are equipped with appropriate sensors or with the help of an external system, such as a wireless sensor network (WSN). The task could be carrying goods in a warehouse application, cleaning in a cleaning operation scenario, or finding victims in a surveillance application. In many scenarios, task locations and requirements are not known beforehand because they emerge randomly in the area. Hence, offline task assignment is not a feasible solution. Therefore, distributed task allocation is needed for such dynamic scenarios.

Task allocation can be determined for single-task (ST), single-robot (SR), and multi-robot (MR) systems, where each robot can perform one task at a time (single-task) and each task requires only one robot (single-robot), and there is more than one robot (multi-robot) coordinating to allocate tasks among themselves in a distributed manner. For example, a first solution can correspond to explicit auction-based coordination in which any of the plurality of robots acts as an auctioneer while others send their bids and then auctioneer assigns the task to the best bidder, as further described herein. A second solution can be based on an adaptive threshold-based implicit coordination in which each robot maintains its threshold values and either accepts or rejects the task based on these thresholds, as further described herein.

The MRTA applications, as further described herein, can include tasks emerging over time in an unpredictable manner, assigning tasks directly once they are available, and assigning tasks to robots considering travel distance, the task's quality satisfaction, and the robot's load balancing. Quality satisfaction is a term to express the match between task's quality requirement and robot's quality.

More specifically, multi-objective task allocation robots can use fuzzy inference system (FIS) in the auction-based approach to produce a single scalar bid value. Fuzzy logic includes three main processes including fuzzification, in which crisp input variables are converted into a fuzzy membership function, inferencing, where the applicable rules are executed, and defuzzification, where the output variable is produced as a crisp value. In the adaptive threshold-based approach robots can determine whether to accept or reject the task based on the stimuli, as further described herein.

For example, imaging objects (e.g., plants) for a disease diagnostic system is an example in which the proposed approaches can be implemented. This system can be an integration of two subsystems including an onsite multi-robot system and a remote sensing system. The aim of remote sensing is to detect and diagnose any unhealthy symptoms in an area of interest, such as diseases, weeds, and pests. If any disease is detected, the remote sensing advertises a new task for the onsite sensing system (multi-robot) which is equipped with appropriate near-range sensors, such as a camera, thermography, chlorophyll fluorescence and hyperspectral sensors. The remote sensing system provides necessary information about a task, such as its location, the amount of resources required (fertilizers/pesticides), and the required quality. A robot's quality can be the quality of its camera resolution, whereas a task's quality requirement is the resolution of the image required, as different diseases require different image resolutions to be detected.

As a result, a unique fuzzy inference system (FIS) for MRTA, as further described herein, can be designed for the robotic networks auction approach to solve the multi-objective task allocation. Alternatively, or additionally, an adaptive multi-threshold task allocation system may be used, and may require less coordination to allocate the tasks.

In one or more aspects of the disclosed subject matter, FIS auction-based and adaptive multi-threshold can be implemented under a dynamic scenario with multi-objective task allocation.

In one embodiment, all robots can be deployed randomly in the area of interest and the tasks appear over time and can be assigned as they appear. A task may be discovered either by mobile sensors or by a static WSN, for example, and the multi-robot system, as further described herein, can respond accordingly and in real time to the dynamically assigned tasks.

Referring now to the drawings, wherein like reference numerals designate identical or corresponding parts throughout the several views.

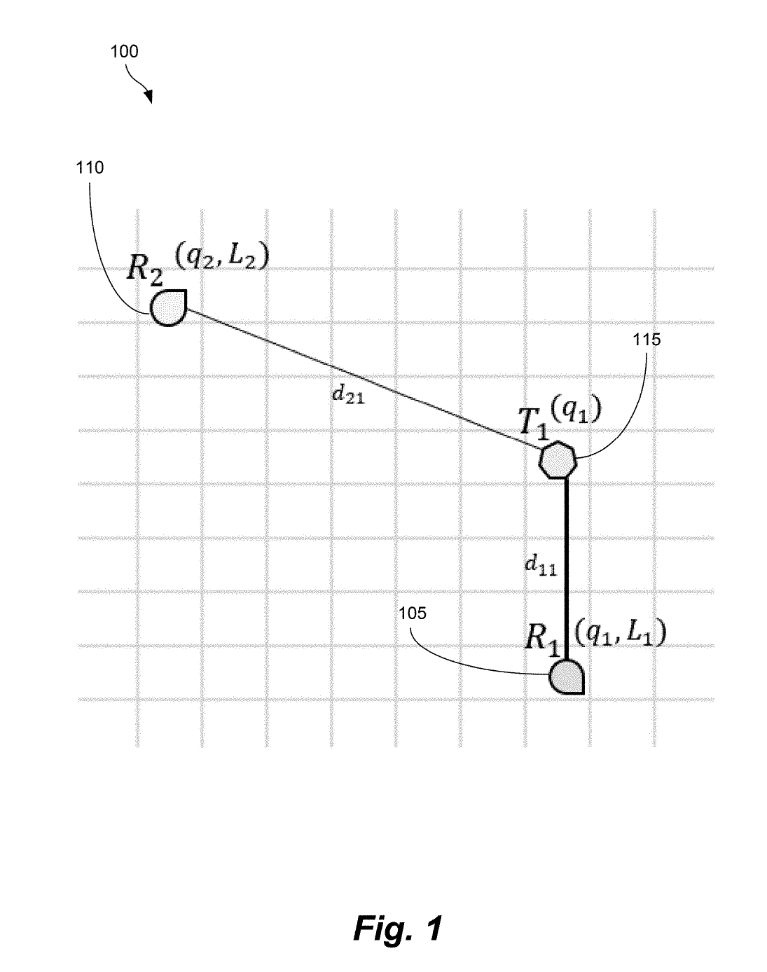

FIG. 1 illustrates an exemplary multi-robot system 100 according to one or more aspects of the disclosed subject matter. The multi-robot system 100 can include two robots 105 (R1), 110 (R2) and one task 115 (T1). The “R” and “T” notation, referring to robot and task, respectively, can correspond to a number identified in the drawings, but may be referred to interchangeably. As shown in FIG. 1, the system includes two robots R1, R2 and one task T1, each task can be declared with a specific quality requirement (e.g., what is the desired execution quality, qⱼ), and each robot maintains its status which include its task execution quality (e.g., how good it is in performing a task, qᵢ) and its current load (e.g., how many task have been assigned to it, Lᵢ). Prior to participating in the task allocation process, a robot Rᵢ can calculate a travel distance (dᵢⱼ) to the task Tᵢ, and the difference between its quality qᵢ and the required quality for the task qⱼ, qᵢⱼ.

The multi-robot system 100 can be communicably coupled via a network (e.g., one or more of network 820 and wherein the robots are mobile nodes that have communication functionality), wherein the robots in the multi-robot system 100 can communicate via the network to assign a task to a robot in a distributed manner considering the following objectives:

1) Minimize the sum of traveled distance per robot.

2) Distribute the load equally among all available robots.

3) Maximize the tasks' quality satisfaction. The optimal is when each task is executed by a robot with the same quality (qᵢ) as the task required quality (qⱼ).

The robots' and tasks' quality settings are further described herein. For example, a task's quality requirements can correspond to Q_{T}={a1,a2,a3 . . . ,ak} and the robotic network can have a set of different quality levels, Q_{R}={q1,q2,q3, . . . ,qz}, such that a number of available robots' quality is less than tasks' required quality (z<k). However, when the task does not have a match with a robot's quality, the task can be executed by another robot that has the smallest quality shift from the required quality. For example, if a task required quality is 5 and the available robots have quality of 1 and 6 only, then from the quality satisfaction perspective, it's better for the task to be executed by a robot with quality 6, since the quality shift is only +1. Therefore, we can classify the tasks' required quality as

$$β = \frac{k}{z} \qquad Eq . 1$$

wherein β represents the number of tasks' quality level under the range of each robot quality. For example, if there are 9 levels of tasks' required quality and only 3 levels of robot's quality, then β=3 meaning each robot's quality covers 3 tasks' required quality.

A fuzzy inference system (FIS) can be used for auction-based MRTA for a system in which the communication channel between robots is available and all robots are within range of each other (e.g., within communication range). A task's details can reach a random single robot from the multi-robot system (e.g., system 100) which will be consider as the auctioneer for that specific task and coordinate the task allocation process. The task allocation process can include opening an auction for the new task by broadcasting task's details, other robots compute their bids (e.g., using the FIS) and send it to the auctioneer, and the auctioneer assigns the task to the robot with the maximum bid. The winning robot can subsequently travel to and execute the assigned task while also participating in any upcoming auctions.

A robot's bid can include a scalar value (fitness value) which can reflect the aforementioned task allocation objectives. However, these objectives can be contradicting. For example, in FIG. 1 the distance between task T₁ to robot R₁ and is less then to R₂, however, it can happen that the task required quality is matched with robot R₂. Therefore, there is a contradiction between quality satisfaction and minimum traveled distance. As a result, the FIS can be used to combine the objectives and to solve the uncertainty of the amount of contribution of each objective into the final fitness value.

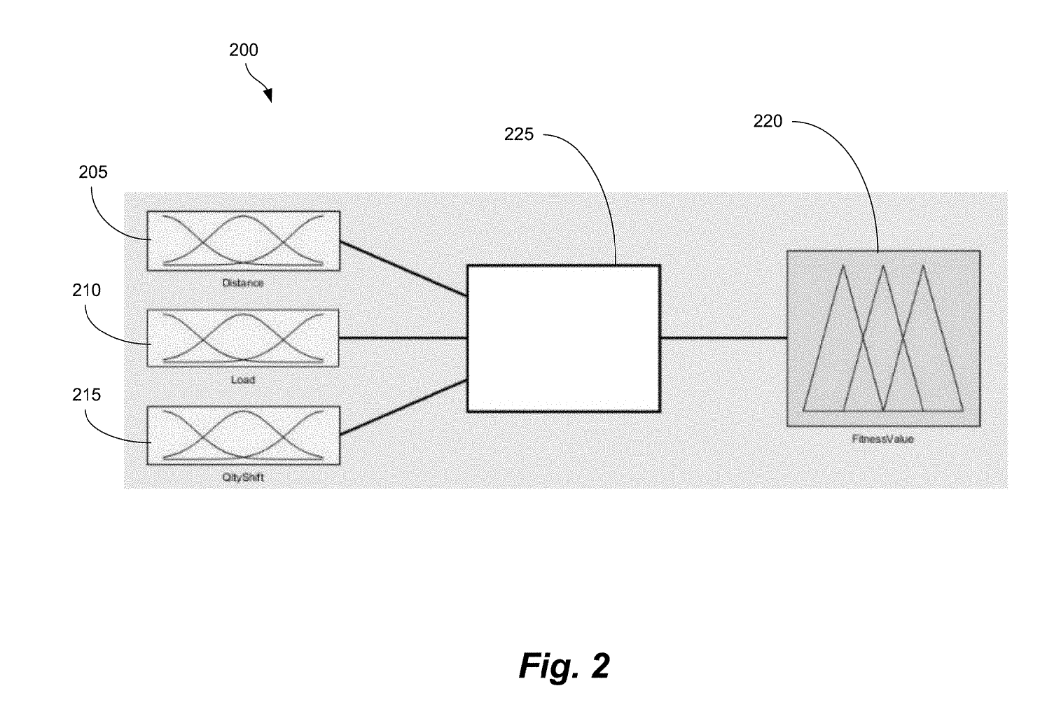

FIG. 2 illustrates exemplary input variables for a fitness FIS system 200 according to one or more aspects of the disclosed subject matter. The design of the fitness FIS system 200 can include defining input variables of the FIS including a traveled distance 205 between a robot Rᵢ and a task Tⱼ (i.e. dᵢⱼ), a current load 210 of a robot (Lᵢ), i.e. current number of assigned tasks to a robot Rᵢ, and a quality shift 215 (i.e., difference in quality between robot's quality and task's required quality, qᵢⱼ). Processing circuitry 225 can receive the input variables and generate an output variable via fuzzy logic evaluation as further described herein. The output variable is a fitness value 220 which can correspond to the fitness value that robot uses in the bid.

In general, the membership functions of the input and output variables along with the inference rules are responsible for specifying the behavior of the FIS. Therefore, these main two components of the FIS can be defined to meet the task allocation objectives as further described herein.

For each of the input variables 205, 210, 215, three membership functions can be defined. The three membership functions can correspond to low, medium, and high, each of which can be defined as triangular-shaped or trapezoidal-shaped, for example, based on the characteristics of the input variable itself. Three functions can be used because each input variable can be classified as having a low, medium, or high value.

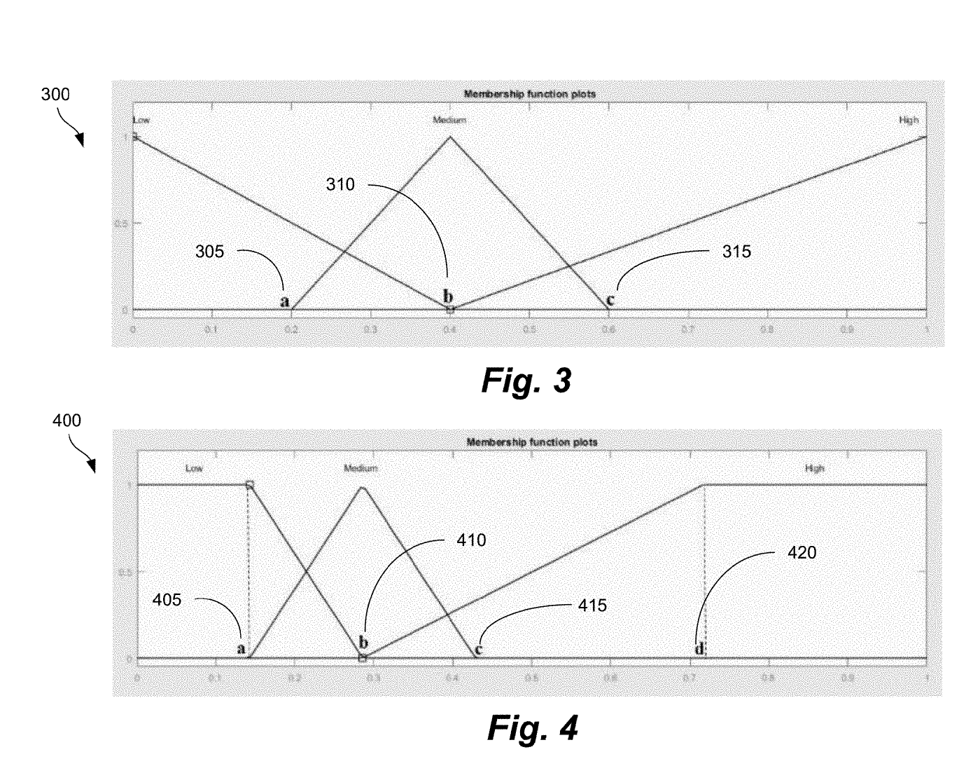

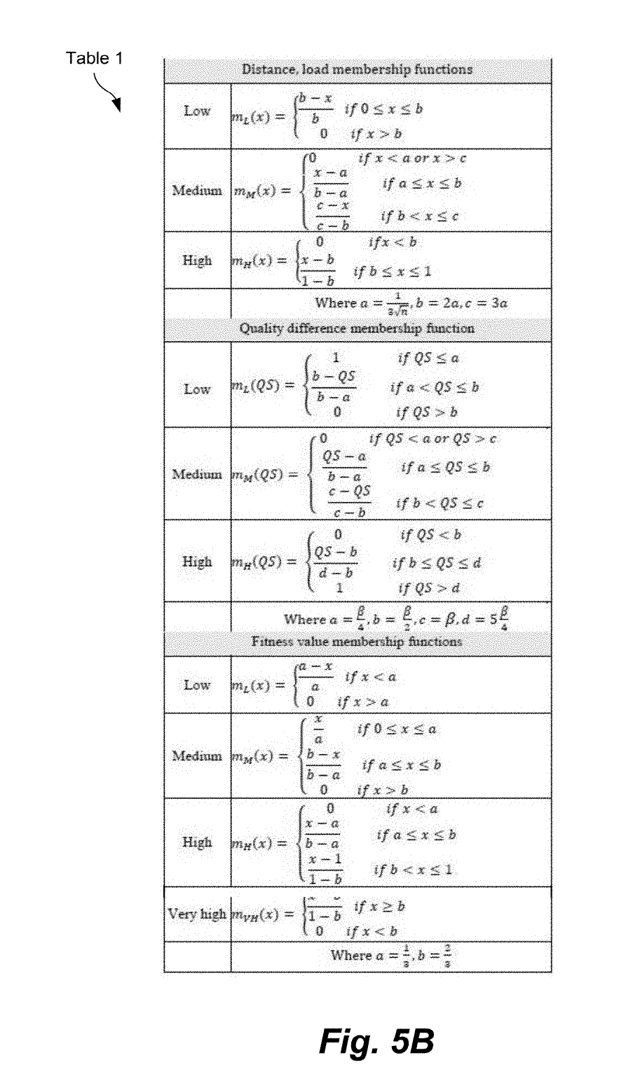

FIG. 3 illustrates the distance input variable (e.g., traveled distance 205) and load input variable (e.g., current load 210) according to one or more aspects of the disclosed subject matter. The distance and load input variables can be formed as three triangular-shaped membership functions in a membership function plot 300. The membership function plot 300 can correspond to a case where the input variable increases and its backwards membership decreases (e.g., a low membership function), and the frontwards membership function increases (e.g., a medium membership function), which is the case for distance and load. The triangular-shaped membership functions can be customized using “a” 305, “b” 310 and “c” 315 variables, which are driven based on the number of robots as shown in the “distance, load membership function” section of Table 1 in FIG. 5B.

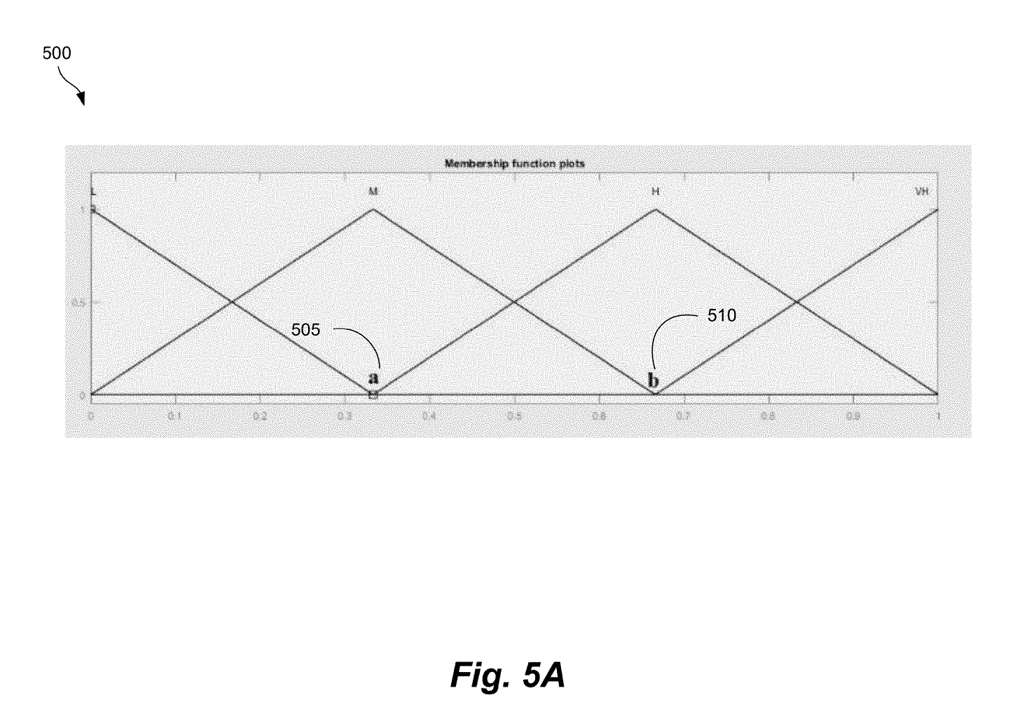

FIG. 4 illustrates the quality input membership function according to one or more aspects of the disclosed subject matter. The quality input variable can include of two trapezoidal-shaped membership functions in a membership function plot 400, wherein the two trapezoidal-shaped membership functions correspond to low and high. Additionally, one triangular-shaped membership function can correspond to medium. Trapezoidal-shaped functions for the low and high membership functions can be used because they include portions where the quality difference is 100% low (i.e., [0, a]) or high (i.e., [d,1]). The medium membership function can correspond to a transportation phase between low and high membership functions and can be presented as a triangular function. Variables “a” 405, “b” 410, “c” 415, and “d” 420 can correspond to the “quality distance membership function” section of Table 1 in FIG. 5B, and each variable is directly driven from variable β (Equation 1), which can determine the range of robot quality. For example, if a quality shift is less than α, its membership function values is one (i.e., low) because it is in that range of robot quality, and if it is greater than “b” 410 then its membership function is zero, and it is partially low if the quality shift is between “a” 405 and “b” 410.

FIG. 5A illustrates the output variable (e.g., fitness value 220) membership function according to one or more aspects of the disclosed subject matter. The fitness value can be represented by four triangular-shaped membership functions in a membership function plot 500. The four triangular-shaped membership functions can correspond to low, medium, high and very high fitness values, for example. Additionally, variables “a” 505 and “b” 510 can correspond to the “fitness value membership functions” section of Table 1 in FIG. 5B, wherein FIG. 5B illustrates a table of membership functions according to one or more aspects of the disclosed subject matter.

In case none of the three objectives have priority over the others, the FIS rules can be defined based on the input level (i.e. low L, medium M, and high H), as shown in Table 2. For example, fitness value is very high (VH) if two of the inputs (traveled distance, current load, and difference in quality) are low and the third one is either low or medium (L, L, L) or (L, L, M).

| Input Variable Set | Output Variable |
|---|---|
| {L, L, L/M} | VH |
| {L, L, H}, {M, M, L} | H |
| {L, M, H}, {M, M, M} | M |
| {H, H, H/M/L}, {H, M, M} | L |

In the adaptive multi-threshold approach, a robot can choose to execute a task based on its response threshold and a stimulus for a task. Therefore, there is no explicit communication between robots to allocate the tasks as in auction-based. The adaptive multi-threshold method can address multi-threshold values instead of a single value such that a robot will not participate in a task unless its stimuli are all greater than that robot's thresholds, for example. Additionally, a communication routine can be used in response to a tie when two robots compete for the same task.

Initially, each robot must maintain the predetermined thresholds. The first threshold can be a distance threshold, for example. The distance threshold must be set such that it defines the area of interest covered by all robots, and the distance threshold can be defined by the following equation:

$${D}_{th} = \frac{\vert A \vert}{2 \sqrt{n}} \qquad Eq . 2$$

wherein n is the number of robots and |A| is the diagonal of the area of interest. For example, the area is a rectangular area for Eq. 2 and four robots in a 10 m by 10 m area, then the diagonal distance of the area is 14.142 m and 2×\sqrt{4} so the threshold is

$${D}_{th} = \frac{14.142 m}{4}$$

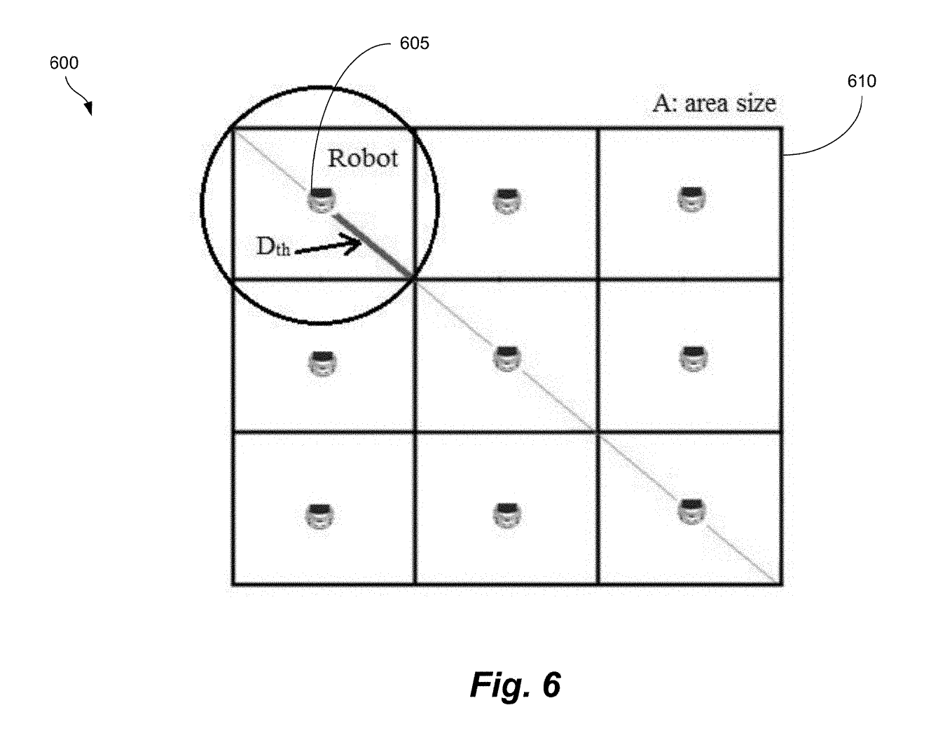

FIG. 6 illustrates an exemplary distance threshold diagram 600 according to one or more aspects of the disclosed subject matter. More specifically, FIG. 6 is an example of the distance threshold Dₜₕ for an area 610 that includes nine robots, wherein each robot (e.g., robot 905) has a distance threshold Dₜₕ in a portion of the area 610. For example, if the area of interest has a diagonal of 1 m and all robots are in the corners of the square area. In the beginning, let Dₜₕ be ⅛ so the covered area by that robot is a circle of diameter of ⅛. If the task is in the middle, then none of the robots can reach this task. So, in the next stage, each robot will extend its coverage by ⅛, for example. Now, Dₜₕ is ¼ which also cannot reach the task. This consecutive increment can continue until at least one robot can reach the task.

A quality shift threshold can correspond to the maximum allowed shift between a robot's quality and a task's quality. The quality shift threshold can be set such that each robot covers a consecutive task quality level. Therefore, the quality shift threshold can be set to keep each robot in its range, and it is calculated using the following equation:

$${Q}_{th} = \frac{β}{2} \qquad Eq . 3$$

where β is computed using Equation 1.

A load threshold can correspond to the maximum number of tasks that a robot can execute (i.e., the maximum load); Lₜₕ=Lₘₐₓ.

Using the adaptive multi-threshold approach, a task can end up in one of the following three cases:

1. Assigned to a single robot.

2. Assigned to more than one robot (tie problem).

3. Not assigned.

The first case is the desired case. However, the tie problem in the second case can be solved using a single broadcast message (e.g., “avoid tie”) that a robot has to send before it attempts to execute the task. The avoid tie message can include a robot's ID and task number, for example. Then, the robot with the maximum ID wins the task. For example, each robot can have a unique numerical value as an ID which can be used to identify the robot (e.g. its MAC address or IP address or any unique identifier) and can help to resolve any tie condition when two robots would win a task equally. For example, if there are 10 robots then they may have IDs as 1, 2, . . . , 10, respectively. In case three, when a task is not assigned in the first iteration, it must be announced again until it is assigned. In each announcement, robots increase their thresholds (Dₜₕ, Qₜₕ) by values related to the ratio between their current load 1 and the maximum load Lₘₐₓ. The increase in quality and distance thresholds are given by the following equations:

$${Q}_{th} ( t ) = \{ \begin{matrix}{Q}_{th} ( t - 1 ) + ∈ , l ( t - 1 ) < {L}_{max} , {Q}_{th} ( t - 1 ) < {Q}_{max} \\ {Q}_{th} ( t - 1 ) , Otherwise\end{matrix} \qquad Eq . 4$$

where ϵ can be set to the one quality level or more (i.e. ϵ=1).

$${D}_{th} ( t ) = \{ \begin{matrix}{D}_{th} ( t - 1 ) * δ ( 1 - \frac{l ( t - 1 )}{{L}_{max}} ) , l ( t - 1 ) < {L}_{max} , {D}_{th} ( t - 1 ) < \frac{{R}_{com}}{2} \\ {D}_{th} ( t - 1 ) , Otherwise\end{matrix}$$

Where R_{com} is the communication range of a robot. In our experiment we set δ=0.5 to decrease the number of iterations required for Dₜₕ to occupy a task (i.e., dᵢⱼ<Dₜₕ).

For example, given a robot in an area A, a robot distance threshold Dₜₕ will occupy any task in the area by the maximum iₜₕ iteration of increase in its Dₜₕ, where i is given by the following equation:

$$i = \frac{log 2}{log ( 1 + δ )}$$

Assuming the extreme case in which a robot is located at the corner of a square area and the task is on the opposite corner, then using equation 2,

$${D}_{th} = \frac{\vert A \vert}{2 \sqrt{n}} = \frac{\sqrt{2}}{\sqrt{1}} = \frac{1}{\sqrt{2}}$$

Given that Dₜₕ(t)=Dₜₕ(t−1)+D_{inc}, the robot will occupy the task when Dₜₕ=|A|.

$$\sqrt{2} = \frac{1}{\sqrt{2}} {( 1 - δ )}^{i} \to i = \frac{log 2}{log ( 1 + δ )}$$

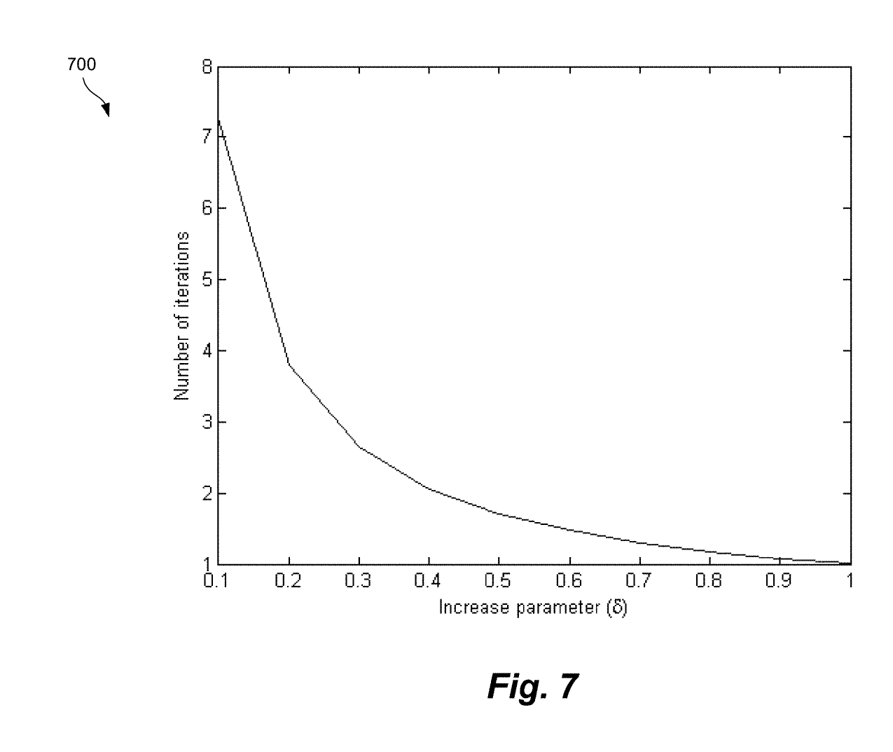

FIG. 7 illustrates a graph 700 of a maximum δ that corresponds to a minimum number of iterations required to satisfy the distance threshold value according to one or more aspects of the disclosed subject matter.

To ensure the communication link's existence, the distance threshold Dₜₕ can be limited to be less than half of the communication range (i.e., Dₜₕ<R_{com2}). Therefore, robots will be able to solve the tie problem as long as they are in range of each other.

The approach was tested by evaluating its performance using Kheperalfi robots on the Webots simulator (Version 8.3.0). The Kheperalll robot is well known and commonly used in such experiments. It is a differential wheeled robot with dimensions of 13 cm in diameter and 7 cm in height, with a ring of nine infrared (IR) distance sensors, which are used to detect obstacles.

Various controllers of the robots can include circuitry configured to implement one or more of the proposed approaches. A PID controller is a feedback control system that continuously calculates the difference between the desired goal and measured current state. A robot uses the PID controller to navigate to a task's location (desired goal), always computes the error (the difference between the current robot location and task location) and tries to minimize it. The PID controller uses odometry to estimate the current robot location and utilizes the IR sensor ring to avoid obstacles while driving a robot towards a task's location.

For example, initially, three robots can be deployed that were assigned quality levels of low, medium, and high with representative numbers of 2, 5, and 8, respectively. Tasks emerge with more quality level requirements which can be represented by levels from very low to very high quality level requirements with numbers from 1 to 9, respectively. Robots and tasks are given a unique color based on their quality level such as gray for the low quality level, blue for the medium quality level, and red for the high quality level.

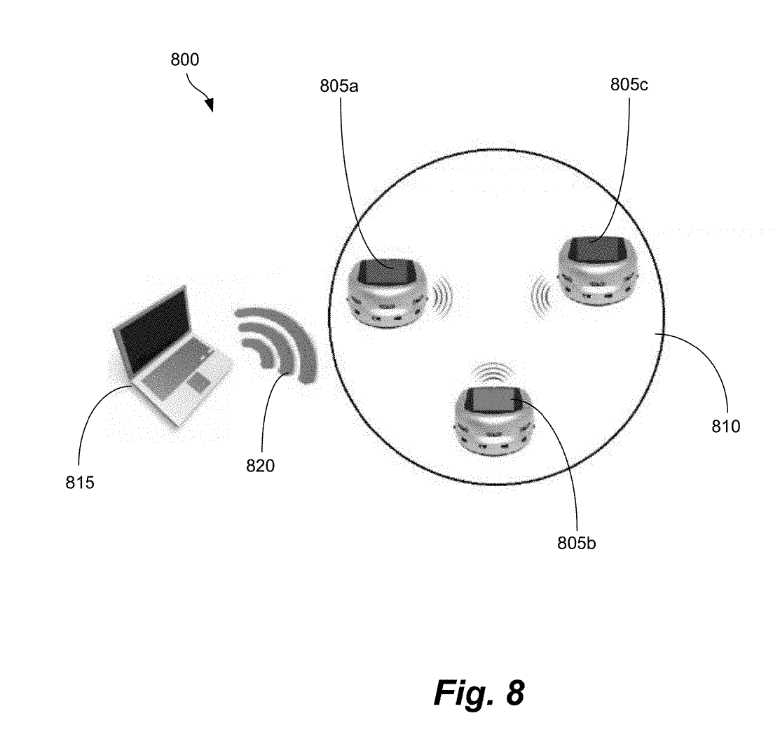

FIG. 8 illustrates an exemplary network schematic diagram 800 according to one or more aspects of the disclosed subject matter. The robots (e.g., 805a-c) form a robotic network 810, wherein the robots 805a-c are communicably coupled (e.g., LAN, WAN, Wi-Fi, Bluetooth, etc.), and they are responsible for receiving tasks from a remote device 815 and then allocating those tasks among themselves. The remote device 815 can be a server, computer, laptop, smartphone, tablet, PDA, and the like, for example. The remote device 815 can be communicably coupled to the robots 805a-c via a network 820. The network 820 can be a public network, such as the Internet, or a private network such as an LAN or WAN network, or any combination thereof and can also include PSTN or ISDN sub-networks. The network 820 can also be wired, such as an Ethernet network, or can be wireless such as a cellular network including EDGE, 3G and 4G wireless cellular systems. The wireless network can also be Wi-Fi, Bluetooth, or any other wireless form of communication that is known. Alternatively, or additionally, the robotic network 810 and the network 820 can be the same network. The robot 805a can correspond to the high quality level, 805b can correspond to the low quality level and 805c can correspond to the medium quality level. As the robots 805a-c in the robotic network 810 work on the allocated tasks, they report their status (e.g., traveled distance, quality satisfaction, and load) to the remote device 815, which can then be used to generate the results.

Table 3 shows the implementation parameters,

TABLE 3

| Parameter | Value |
|---|---|
| Number of tasks | (12, 24, 36, 48) |
| Number of robots' quality | 3 levels |
| Number of tasks' required quality | 9 levels |
| Area size | 50 m × 50 m |
| PID parameters Kₚ, Kᵢ, K_{d} | (2, 0.01, 0.04) |
| Number of Iterations | 35 |

The implementation can start by deploying the robots uniformly in the area. Then, tasks are generated following exponential inter-arrival times, uniform locations, and quality requirements. A task advertisement message can be produced with each newly generated task in the area to a random robot which then considers itself as the auctioneer for that task and opens a new auction-process. The task advertisement message can include the details of the task (e.g., location and quality level requirement).

To measure the performance of the proposed FIS auction-based and adaptive multi-threshold approaches, each approach can be tested in different scenarios. Then the results can be compared based on various performance metrics including a sum of the total traveled distance (TTD), which is the sum of the distance traveled for a robot to accomplish all of its assigned tasks. The distance traveled by a robot Rᵢ that is assigned k number of tasks is computed as follows:

$$TTD = {\sum }_{i = 1}^{n} {\sum }_{j = 1}^{k} {d}_{ij}$$

where dᵢⱼ is the distance between the robot. Rᵢ's location and the nearest task Tⱼ, n number of robots, and k number of executed tasks by each robot.

Another performance metric can be quality satisfaction, which measures the quality satisfaction of the tasks. If the tasks have been assigned to robots with similar qualities, the average quality level for all assigned tasks for each individual robot will be nearly equal to the robot's quality level, and it is computed as follows:

$$\overline{{Q}_{l}} = \frac{{\sum }_{j = 1}^{l} {q}_{j}}{l}$$

where l is the number of assigned tasks to a robot Rᵢ, and qj is a task's Tⱼ quality requirement.

Further, a load balance performance metric can be measure, wherein the load balance indicates whether the total load (e.g., the number of tasks, m) has been divided equally among the available robots or not. The optimal load balancing is when all robots execute the same number of tasks.

$$\overline{{L}_{l}} = \frac{n}{m}$$

where n is number of tasks and m is the number of robots. Lᵢ can be compared to the actual number of assigned task to each robot.

The implementation results of the FIS auction-based and adaptive multi-threshold task allocation approaches based on the aforementioned performance metrics can correspond to the following results. First, the total traveled distance can be computed for the two approaches with a consideration of satisfying all the three objectives. Therefore, traveled distance can be normalized to the lower bound (LB), where only distance is considered, and to the upper bound (UB), where the distance factor has been ignored in the assignment process. Then, the extent to which each approach drops from the UB and increases from the LB can be calculated using the following equations:

$$+ LB = \frac{TD - LB}{LB} , - UB = \frac{UB - TD}{UB}$$

where +LB denotes the percentage increase from the LB, −UB denotes the percentage decrease from the UB, and TD is the traveled distance using the proposed approaches.

The results reveal that the traveled distance using the adaptive multi-threshold approach is less than the traveled distance using the FIS auction-based approach, as shown in Table 4. This result occurs because when robots use the adaptive multi-threshold approach, they maintain an optimal distance threshold Dₜₕ and increase it gradually, and this yields a higher probability for the robot that is close to the task to occupy it first.

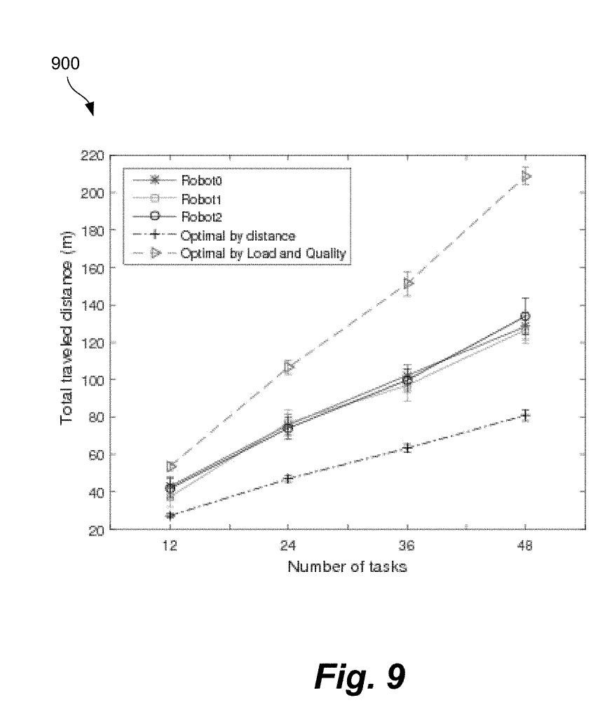

FIG. 9 illustrates a total traveled distance plot 900 of the FIS auction-based approach according to one or more aspects of the disclosed subject matter.

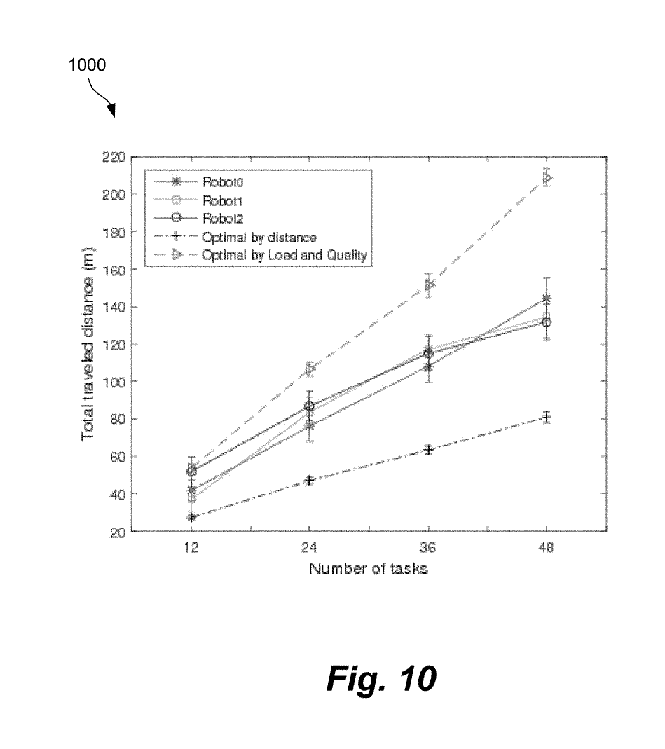

FIG. 10 illustrates a total traveled distance plot 1000 of the adaptive multi-threshold approach according to one or more aspects of the disclosed subject matter.

FIGS. 9 and 10 illustrate that the traveled distances in both approaches tend to be closer to the LB than to the UB, as is also shown in Table 4. However, due to the coordination in FIS auction-based, the all robots have almost traveled the same distance, which is not the case with adaptive multi-threshold.

Table 4 corresponds to total traveled distance comparison between the two proposed methods with respect to the LB and UB.

TABLE 4

| | | | | |
|---|---|---|---|---|
| Number of | 12 | 24 | 36 | 48 |
| Tasks | | | | |
| LB (m) | 27 | 47 | 63 | 81 |
| UB (m) | 54 | 107 | 151 | 209 |
| FIS auction- | 44 | 82 | 113 | 137 |
| based (m) | | | | |
| +LB | 59% | 75% | 79% | 69% |
| −UB | 19% | 23% | 25% | 34% |
| Adaptive mulit- | 41 | 76 | 100 | 130 |
| threshold (m) | | | | |
| +LB | 49% | 61% | 57% | 60% |
| −UB | 24% | 29% | 34% | 38% |

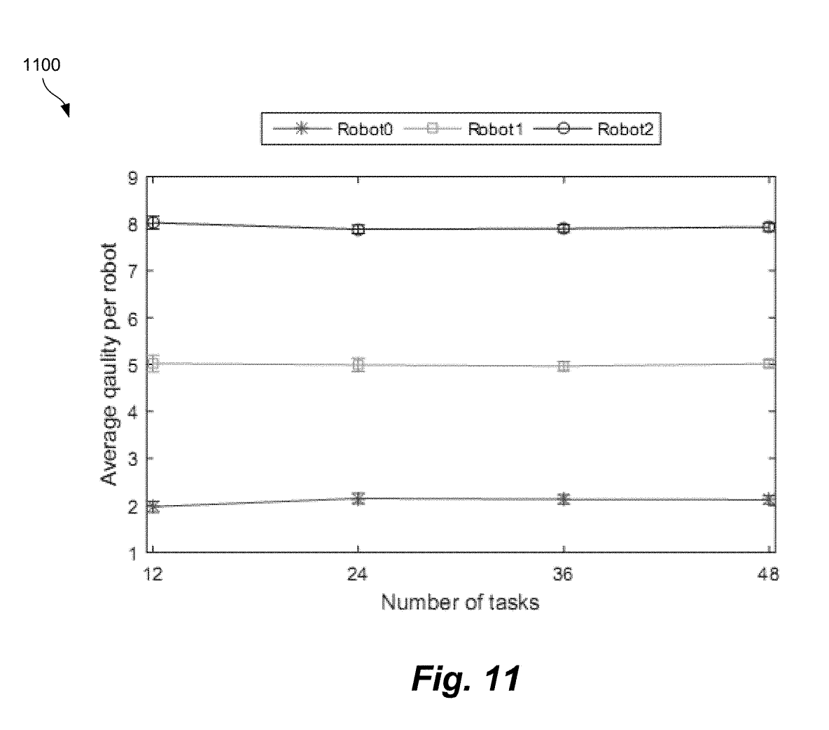

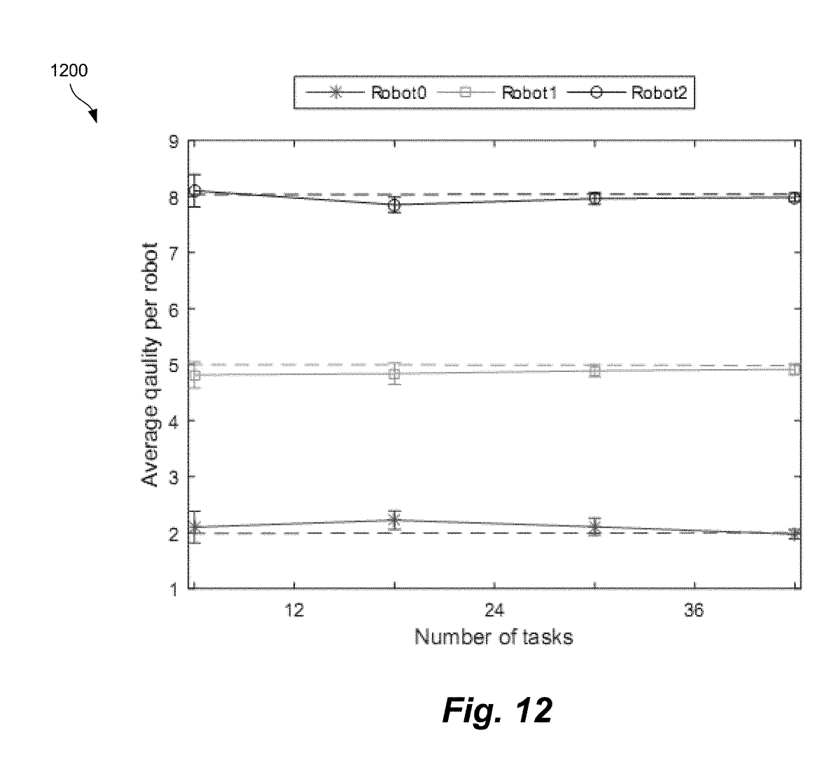

In terms of quality satisfaction, a better quality satisfaction using FIS auction-based approach is expected. Because of the relatively small increase in Qₜₕ at each iteration, there is no significant difference in the quality satisfaction for the two approaches, where almost every robot performs tasks that are within its quality range, as shown in FIGS. 11 and 12.

FIG. 11 illustrates a plot 1100 corresponding to average quality of executed tasks per robot with different numbers of tasks in the FIS auction-based approach according to one or more aspects of the disclosed subject matter.

FIG. 12 illustrates a plot 1200 corresponding to average quality of executed tasks per robot with different numbers of tasks in the adaptive multi-threshold approach according to one or more aspects of the disclosed subject matter.

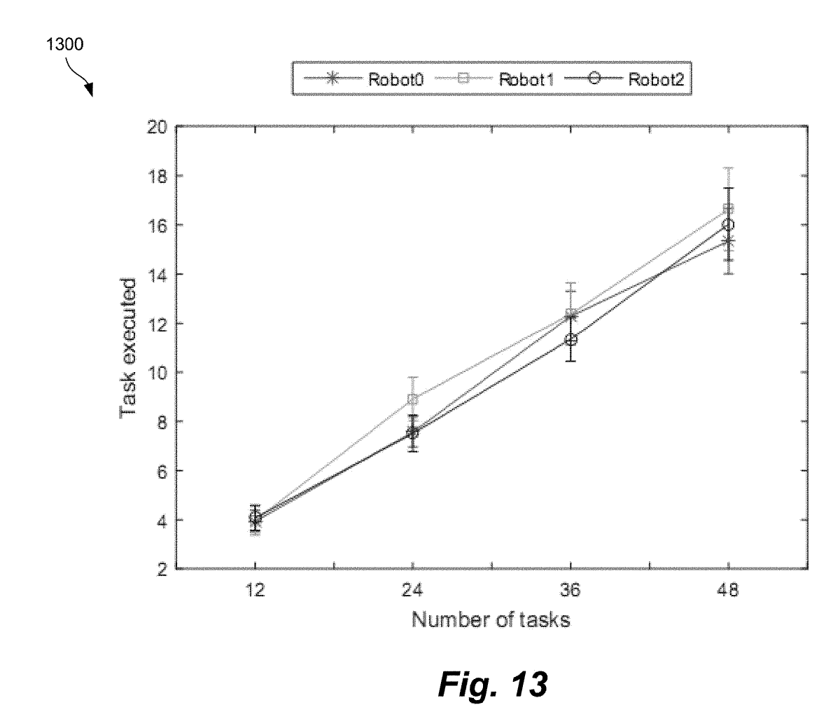

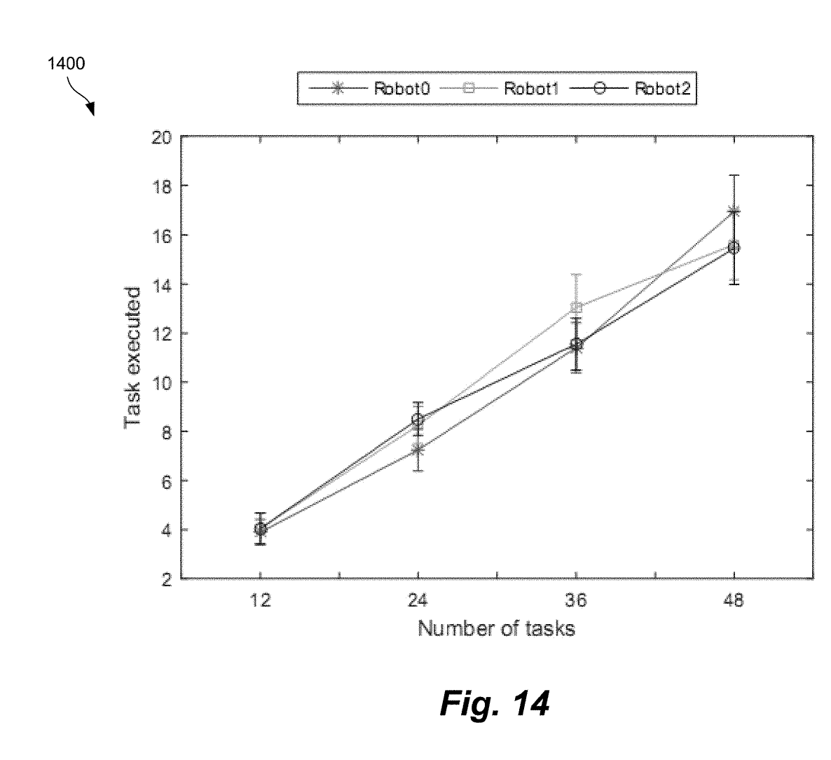

FIG. 13 illustrates a plot 1300 corresponding to average number of task executions per robot in the FIS auction-based approach according to one or more aspects of the disclosed subject matter. In the FIS auction-based approach, the load of each robot deviates from the optimal value by ±9.4%, as shown in FIG. 13. However, in the adaptive multi-threshold approach, as shown in FIG. 14, the deviation from the optimal load is ±10.62% due to the absence of explicit coordination. The adaptive multi-threshold approach maximized the load balancing objective by tie the increase of Dₜₕ, Qₜₕ with the current load, see equation 4 and 5. For example, in the threshold-based approach, if no robot wins the task because it is more than the preset thresholds Dₜₕ, Qₜₕ. Then, the unassigned task can be announced again and each robot will increase their thresholds Dₜₕ, and Qₜₕ with each new announcement for the same task. The process can repeat until at least one robot has Dₜₕ,Qₜₕ sufficient enough to accommodate and win the task.

FIG. 14 illustrates a plot 1400 of average number of task executions per robot in the adaptive multi-threshold approach according to one or more aspects of the disclosed subject matter.

A comparison between FIS auction-based and adaptive multi-thresholds task allocation can be performed as has been described herein. The task allocation objectives for both approaches can include 1) minimize the total traveled distance, 2) maximize the quality satisfaction, and 3) balance the load among available robots.

The implementations of the approaches indicate that adaptive multi-thresholds outperforms FIS auction-based in terms of traveled distance (robots traveled 10% less), whereas FIS auction-based slightly performs better in terms of workload balancing, and both approaches almost result same performance in terms of quality satisfaction.

It should be appreciated that the implementation can be configured to include a framework that includes task waiting time and task priority. Auction approaches may suffer from communication overhead, particularly if the number of robots is large, and challenges may also arise if there are a small number of bidders in the auction. As a solution, hop count can be used to expand or narrow the pool of auction process participants.

The system includes various advantages including online applications, for example. In such applications, there does not need to be prior knowledge about the requested tasks and existing algorithms would fail as a result. For instance, in search and rescue applications, the agents (i.e. robots) have prior knowledge on what to do (e.g., it is all ad hoc). Therefore, it is advantageous to have a scheme that reacts efficiently to the on-demand tasks. Furthermore, multi-objective is critical for achieving effective robotics network deployment. As demonstrated herein, several objectives can be considered including traveled distance, quality, energy, etc.

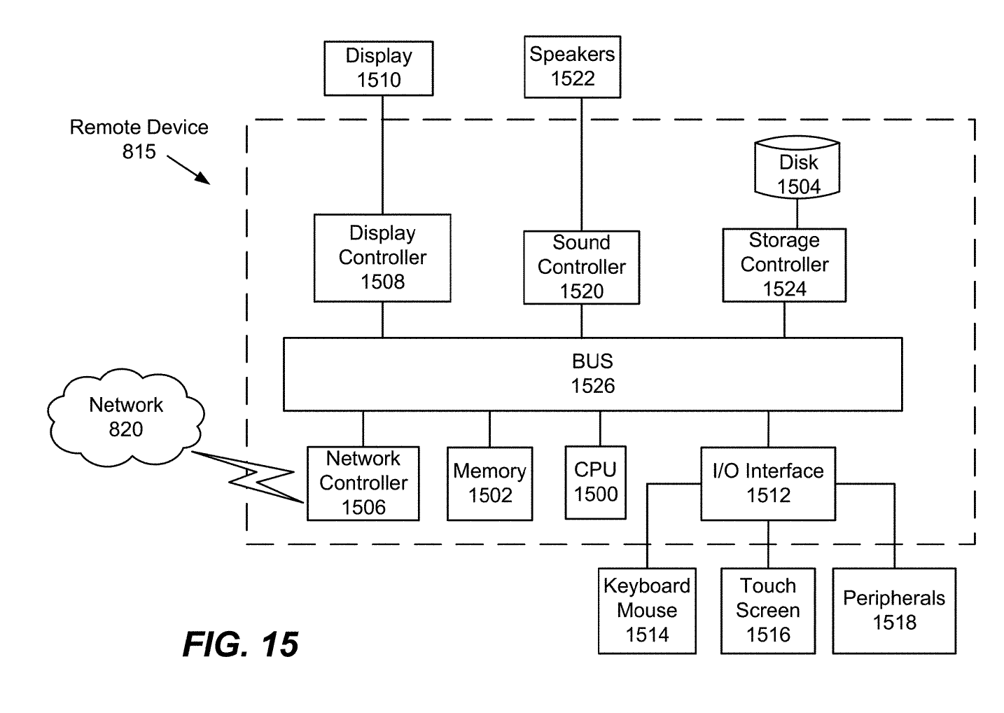

Next, a hardware description of a computer/device (such as the remote device 815) according to exemplary embodiments is described with reference to FIG. 15. The hardware description described herein can be a hardware description of the remote device 815. In FIG. 15, the remote device 815 includes a CPU 1500 which performs one or more of the processes described above/below. The process data and instructions may be stored in memory 1502. These processes and instructions may also be stored on a storage medium disk 1504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the remote device 815 communicates, such as a server or computer.

Further, the claimed advancements may be provided as a utility application, background daemon, or component of an operating system, or combination thereof, executing in conjunction with CPU 1500 and an operating system such as Microsoft Windows, UNIX, Solaris, LINUX, Apple MAC-OS and other systems known to those skilled in the art.

The hardware elements in order to achieve the remote device 815 may be realized by various circuitry elements. Further, each of the functions of the above described embodiments may be implemented by circuitry, which includes one or more processing circuits. A processing circuit includes a particularly programmed processor, for example, processor (CPU) 1500, as shown in FIG. 15. A processing circuit also includes devices such as an application specific integrated circuit (ASIC) and conventional circuit components arranged to perform the recited functions.

In FIG. 15, the remote device 815 includes a CPU 1500 which performs the processes described above. The remote device 815 may be a general-purpose computer or a particular, special-purpose machine. In one embodiment, the remote device 815 becomes a particular, special-purpose machine when the processor 1500 is programmed to perform mobile keyboard content delivery.

Alternatively, or additionally, the CPU 1500 may be implemented on an FPGA, ASIC, PLD or using discrete logic circuits, as one of ordinary skill in the art would recognize. Further, CPU 1500 may be implemented as multiple processors cooperatively working in parallel to perform the instructions of the inventive processes described above.

The remote device 815 in FIG. 15 also includes a network controller 1506, such as an Intel Ethernet PRO network interface card from Intel Corporation of America, for interfacing with network 820. As can be appreciated, the network 820 can be a public network, such as the Internet, or a private network such as an LAN or WAN network, or any combination thereof and can also include PSTN or ISDN sub-networks. The network 820 can also be wired, such as an Ethernet network, or can be wireless such as a cellular network including EDGE, 3G and 4G wireless cellular systems. The wireless network can also be WiFi, Bluetooth, or any other wireless form of communication that is known.

The remote device 815 further includes a display controller 1508, such as a graphics card or graphics adaptor for interfacing with display 1510, such as a monitor. A general purpose I/O interface 1512 interfaces with a keyboard and/or mouse 1514 as well as a touch screen panel 1516 on or separate from display 1510. General purpose I/O interface also connects to a variety of peripherals 1518 including printers and scanners.

A sound controller 1520 is also provided in the remote device 815 to interface with speakers/microphone 1522 thereby providing sounds and/or music.

The general purpose storage controller 1524 connects the storage medium disk 1504 with communication bus 1526, which may be an ISA, EISA, VESA, PCI, or similar, for interconnecting all of the components of the remote device 815. A description of the general features and functionality of the display 1510, keyboard and/or mouse 1514, as well as the display controller 1508, storage controller 1524, network controller 1506, sound controller 1520, and general purpose I/O interface 1512 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be perforated on modules or hardware not identical to those described. Accordingly, other implementations are within the scope that may be claimed.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicants) intend(s) to embrace all such alternatives, modifications, equivalents, and variations that are within the spirit and scope of the disclosed subject matter.

1. A multi-robot task allocation system, comprising:
a plurality of robots communicably coupled via a network; and
a remote device communicably coupled to the plurality of robots via the network, wherein each of the plurality of robots includes processing circuitry configured to
determine when an auction to perform a task is open for bidding,
calculate a bid for the task,
transmit the bid to an auctioneer,
receive allocation of the task in response to transmitting the maximum bid, and
travel to and execute the allocated task in response to receiving allocation of the task, while also participating in any subsequent auctions.

2. The multi-robot task allocation system of claim 1, wherein the processing circuitry is further configured to
receive the task from the remote device, wherein any one of the plurality of robots can receive the task from the remote device and the robot that receives the task is the auctioneer,
in response to being the auctioneer, open an auction for bids from each robot in the plurality of robots,
receive bids for the task from each robot in the plurality of robots,
determine which robot transmitted the maximum bid for the task, and
allocate the task to the robot with the highest bid for the task.

3. The multi-robot task allocation system of claim 1, wherein the remote device includes processing circuitry configured to
generate tasks,
transmit tasks to the plurality of robots, and
receive results of the completed tasks.

4. The multi-robot task allocation system of claim 1, wherein each robot calculates a bid for the task using a predetermined fuzzy inference system.

5. The multi-robot task allocation system of claim 4, wherein inputs of the fuzzy inference system include distance, load, and quality shift.

6. The multi-robot task allocation system of claim 1, wherein the processing circuitry is further configured to
dynamically allocate tasks via distributed task allocation.

7. The multi-robot task allocation system of claim 1, wherein the processing circuitry is further configured to
maintain a distance threshold, wherein the distance threshold corresponds to an area of interest covered by each robot of the plurality of robots, wherein a total of the area of interest of each robot of the plurality of robots corresponds to a total area of interest for the plurality of robots.

8. The multi-robot task allocation system of claim 1, wherein the processing circuitry is further configured to
maintain a quality shift threshold, wherein the quality shift threshold corresponds to a maximum allowed shift between a robot's quality and a task quality.

9. The multi-robot task allocation system of claim 1, wherein the processing circuitry is further configured to
maintain a load threshold, wherein the load threshold corresponds to a maximum number of tasks that a robot from the plurality of robots can execute.

10. A method of multi-robot task allocation, comprising:
determining, via processing circuitry, when an auction to perform a task is open for bidding;
calculating, via the processing circuitry, a bid for the task;
transmitting, via the processing circuitry, the bid to an auctioneer;
receiving, via the processing circuitry, allocation of the task in response to transmitting the maximum bid; and
traveling to and executing, via the processing circuitry, the allocated task in response to receiving allocation of the task, while also participating in any subsequent auctions.

11. The method of claim 10, further comprising:
receiving the task from a remote device, wherein any one of a plurality of robots can receive the task from the remote device and a robot from the plurality of robots that receives the task is the auctioneer;
in response to being the auctioneer, opening an auction for bids from each robot in the plurality of robots;
receiving bids for the task from each robot in the plurality of robots;
determining which robot transmitted the maximum bid for the task; and
allocating the task to the robot with the highest bid for the task.

12. The method of claim 10, further comprising:
generating tasks via a remote device;
transmitting tasks to the plurality of robots via the remote device, and
receiving results of the completed tasks from the plurality of robots when any robot has completed the task allocated to that robot.

13. The method of claim 10, wherein each robot calculates a bid for the task using a predetermined fuzzy inference system.

14. The method of claim 13, wherein inputs of the fuzzy inference system include distance, load, and quality shift.

15. The method of claim 10, further comprising:
dynamically allocating tasks via distributed task allocation.

16. The method of claim 10, further comprising:
maintaining a distance threshold, wherein the distance threshold corresponds to an area of interest covered by each robot of the plurality of robots, wherein a total of the area of interest of each robot of the plurality of robots corresponds to a total area of interest for the plurality of robots.

17. The method of claim 10, further comprising:
maintaining a quality shill threshold, wherein the quality shift threshold corresponds to a maximum allowed shift between a robot's quality and a task quality.

18. The method of claim 10, further comprising:
maintaining a load threshold, wherein the load threshold corresponds to a maximum number of tasks that a robot from the plurality of robots can execute.

19. A non-transitory computer-readable storage medium storing computer-readable instructions that, when executed by a computer, cause the computer to perform the method of:
determining when an auction to perform a task is open for bidding;
calculating a bid for the task;
transmitting the bid to an auctioneer;
receiving allocation of the task in response to transmitting the maximum bid; and
traveling to and executing the allocated task in response to receiving allocation of the task, while also participating in any subsequent auctions.

20. The non-transitory computer-readable storage medium of claim 19, further comprising:
receiving the task from a remote device, wherein any one of a plurality of robots can receive the task from the remote device and a robot from the plurality of robots that receives the task is the auctioneer;
in response to being the auctioneer, opening an auction for bids from each robot in the plurality of robots;
receiving bids for the task from each robot in the plurality of robots;
determining which robot transmitted the maximum bid for the task; and
allocating the task to the robot with the highest bid for the task.
